(19) United States
(12) Patent Application Publication
(10) Pub. No.: US 2012/0007712 A1
(43) Pub. Date: Jan. 12, 2012

(54) NON-CONTACT CONTROL METHOD AND DEVICE

(75) Inventor: Chia Chun Tung, Taipei City (TW)

(73) Assignee: DEUTRON ELECTRONICS CORP, Taipei City (TW)

(21) Appl. No.: 12/833,447

(22) Filed: Jul. 9, 2010

(51) Int. Cl. G05B 19/00

(52) U.S. Cl. 340/5.72

(57) ABSTRACT

A non-contact control method and a non-contact control device are applied to a lock control device in a non-contact mode for manipulation. The non-contact control device includes a master control module and a slave control module. Both the master control module and the slave control module include a radio frequency identify (RFID) component and a Bluetooth component. In the master control module and the slave control module, the RFID component serves as first-layer authentication and unlocking and starts the Bluetooth component, and the Bluetooth component serves as second-layer authentication and unlocking and triggers a circuit control device. The master control module actively starts the slave control module and performs pairing and unlocking, so as to achieve a non-contact locking and control mode with low energy consumption and high security.

### BACKGROUND OF THE INVENTION

1. Field of the Invention

The present invention relates to a non-contact control method and a non-contact control device, and more particularly to a non-contact control method and a non-contact control device integrating RFID and Bluetooth transmission mechanisms.

2. Related Art

Conventionally, vehicle keys are mechanical keys for opening vehicle doors or starting vehicles. However, concave-convex engraved patterns of the mechanical keys are easily copied, and the vehicle doors are easily damaged by external force and opened. Therefore, doubts about the security of the mechanical keys and latch tools are raised to a considerable degree.

Accordingly, a non-contact key (keyless) is developed. Generally, the non-contact key adopts radio frequency identify (RFID) as a technology of sending and receiving signals. An RFID Reader is arranged on the vehicle for reading data of an RFID tag on the key. The RFID tag stores a unique identification code, which can be read by the RFID Reader. When the RFID Reader judges that the identification code of the RFID tag satisfies a preset value, the vehicle is allowed to be started. Although the non-contact latch tool cannot be easily damaged by the external force and opened, during an identification code transmission process performed by the RFID tag and the RFID Reader, the identification code still may be pirated. Therefore, the non-contact key still has the risk of being cracked.

Another non-contact key adopts Bluetooth as a transmission technology. When a Bluetooth transmitting end and a Bluetooth receiving end transmit data, a used frequency is switched continuously. Furthermore, the transmitted data is encrypted with a special mechanism. Therefore, as compared with the RFID technology, the probability of being cracked of the data transmitted through Bluetooth is reduced significantly. That is to say, the security of the data transmitted through the Bluetooth is much higher than that transmitted through the RFID.

However, if a Bluetooth transmitter is arranged on the non-contact key, power consumption required by the Bluetooth transmitter is much higher than the RFID tag. Furthermore, generally, when the Bluetooth transmitter is used for unlocking, the Bluetooth transmitter on the non-contact key actively searches another Bluetooth transmitter, and after the Bluetooth transmitter on the non-contact key actively completes pairing, the vehicle is allowed to be started. Therefore, the Bluetooth transmitter on the non-contact key is required to be designed specially, or is controlled by a special firmware, so as to achieve the above function.

In short, the non-contact key can adopt the RFID or the Bluetooth as a wireless transmission mechanism, but both of the two technologies have their own advantages and disadvantages. The RFID has the advantage of being power-saving, but still has security doubts. On the contrary, the security of the Bluetooth is much higher than the RFID, but the power consumption is also much higher than RFID. That is to say, although the wireless transmission mechanism, for example, the RFID or the Bluetooth, is proposed in the prior art, a wireless transmission mechanism having the advantages of being power-saving and having the high security does not exist.

### SUMMARY OF THE INVENTION

Accordingly, the present invention is a non-contact control device, which has advantages of being power-saving and having high security.

The present invention provides a non-contact control device, which comprises a master control module and a slave control module. The master control module is electrically connected to a circuit control device. The master control module comprises an RFID emitter, a first Bluetooth transceiver, and a switch. The slave control module comprises an RFID receiver and a second Bluetooth transceiver.

The switch is used to turn on the RFID emitter and the first Bluetooth transceiver of the master control module, and the RFID emitter sends a low-frequency start signal to the RFID receiver, so as to turn on the second Bluetooth transceiver. The first Bluetooth transceiver sends a searching signal to the second Bluetooth transceiver, and the second Bluetooth transceiver returns encrypted data to the first Bluetooth transceiver, such that the master control module sends a trigger signal to the circuit control device.

In view of the above, in the non-contact control device and the non-contact control method according to the present invention, the master control module actively turns on the slave control module, such that the slave control module is maintained at a sleep and power-saving mode usually, so as to save power consumption. Furthermore, the RFID receiver firstly identifies whether the low-frequency start signal is correct, and the first Bluetooth transceiver also identifies an encrypted signal. That is to say, the non-contact control device and the non-contact control method require double identification, so as to reduce probability of being pirated, thereby further improving security in use.

### BRIEF DESCRIPTION OF THE DRAWINGS

The present invention will become more fully understood from the detailed description given herein below for illustration only, and thus are not limitative of the present invention, and wherein:

FIG. 1 is a system block diagram of a master control module;

FIG. 2 is a system block diagram of a first embodiment of a slave control module;

FIG. 3 is a system block diagram of a second embodiment of a slave control module;

FIG. 4 is a system block diagram of a third embodiment of a slave control module;

FIG. 5 is a flow chart of a first embodiment of a non-contact control method;

FIG. 6 is a flow chart of a second embodiment of a non-contact control method;

FIG. 7 is a flow chart of a third embodiment of a non-contact control method; and

FIG. 8 is a flow chart of a fourth embodiment of the non-contact control method.

### DETAILED DESCRIPTION OF THE INVENTION

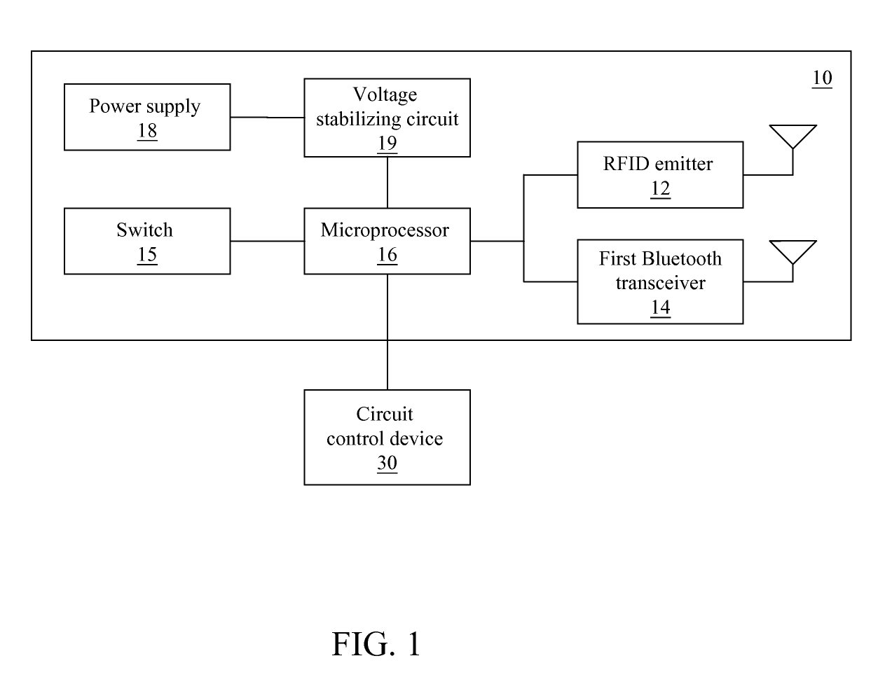

FIGS. 1 to 4 are system architectural diagrams of a non-contact control device according to the present invention. The non-contact control device comprises a master control module 10 and a slave control module 20.

FIG. 1 is a system block diagram of a master control module. Referring to FIG. 1, the master control module 10 comprises an RFID emitter 12 (a first RFID component), a first Bluetooth transceiver 14 (a first Bluetooth component), a switch 15, a first microprocessor 16, and a power supply 18.

The master control module 10 may be a latch tool installed in a body of a vehicle. The master control module 10 is electrically connected to a circuit control device 30. The master control module 10 transmits a trigger signal to the circuit control device 30. When receiving the trigger signal, the circuit control device 30 supplies power to an engine switch, so as to allow the vehicle to be started. The power of the master control module 10 is supplied by the power supply 18. The power supply 18 may be a storage battery (a battery jar) of the vehicle. When the vehicle is started, a pulse current is generated in an instant. Therefore, the power supply 18 may provide a stable voltage for the master control module 10 after being processed by a voltage stabilizing circuit 19. In addition to the function of stabilizing the voltage, the voltage stabilizing circuit 19 can also remove interferences of static electricity.

The RFID emitter 12 is an RFID Reader used to emit an RFID low-frequency start signal. The first Bluetooth transceiver 14 is a wireless transmission element satisfying Bluetooth communication specifications. The RFID emitter 12, the first Bluetooth transceiver 14, and the first microprocessor 16 can be integrated into a system-on-chip (SOC) integrated circuit (IC), or each is an individual IC.

The first microprocessor 16 is electrically connected to a switch 15. When a user changes a state of the switch 15, for example, switches the switch 15 from “OFF” to “ON”, the switch 15 transmits a start signal to the first microprocessor 16. The first microprocessor 16 turns on the RFID emitter 12 and the first Bluetooth transceiver 14. Here, the RFID emitter 12 sends a low-frequency start signal, and the first Bluetooth transceiver 14 searches whether another Bluetooth transceiver exists nearby.

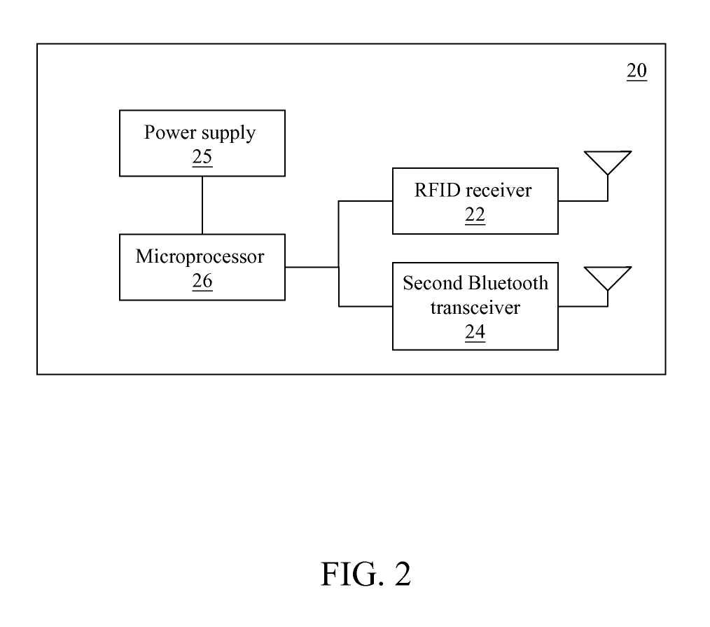

FIG. 2 is a system block diagram of a first embodiment of a slave control module. Referring to FIG. 2, the slave control module 20 comprises an RFID receiver 22 (a second RFID component), a second Bluetooth transceiver 24 (a second Bluetooth component), and a second microprocessor 26.

The slave control module 20 is disposed in a non-contact key, and is used to interact with a master control module 10.

Power of the slave control module 20 is supplied by a power supply 25. The power supply 25 is powered by a common battery, and the power is converted by a direct current (DC)/DC and then is supplied to the slave control module 20.

The RFID receiver 22 is an RFID tag. The second Bluetooth transceiver 24 is a wireless transmission element satisfying Bluetooth communication specifications. The RFID receiver 22, the second Bluetooth transceiver 24, and the second microprocessor 26 can be integrated into an SOC IC, or each is an individual IC.

The second microprocessor 26 is electrically connected to the RFID receiver 22 and the second Bluetooth transceiver 24. The second microprocessor 26 is in an OFF mode usually. When the RFID receiver 22 receives the low-frequency start signal emitted by the RFID emitter 12, and identifies that the low-frequency start signal is correct, the RFID receiver 22 transmits an evoke signal to the second microprocessor 26.

Here, the second microprocessor 26 turns on the second Bluetooth transceiver 24. The second Bluetooth transceiver 24 receives the searching signal of the first Bluetooth transceiver 14, and returns an encrypted signal to the first Bluetooth transceiver 14. The first Bluetooth transceiver 14 identifies the encrypted signal. After identifying that the encrypted signal is correct, the master control module 10 transmits a trigger signal to the circuit control device 30, so as to allow the user to start the vehicle. The detailed operation modes of the master control module 10 and the slave control module 20 are described in detail hereinafter.

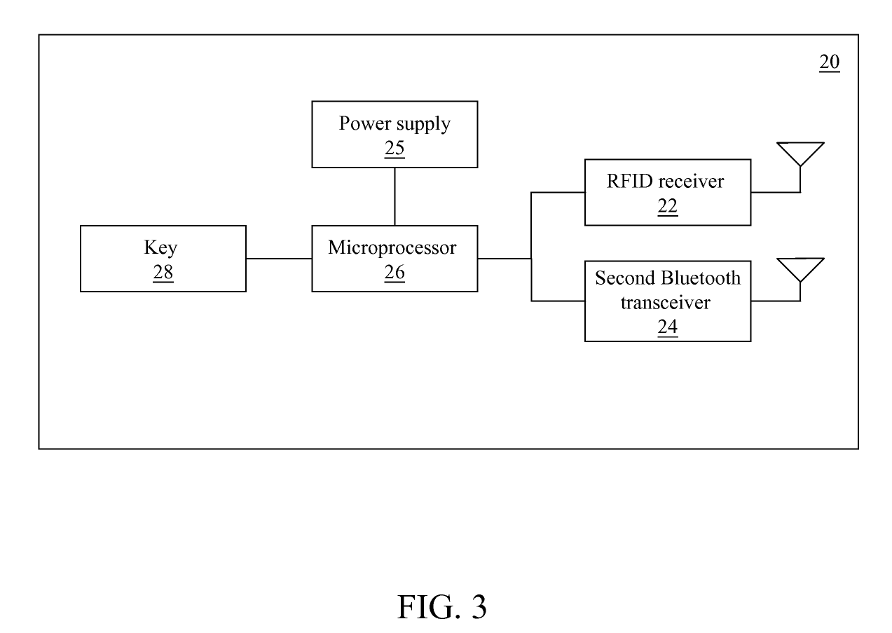

FIG. 3 is a system block diagram of a second embodiment of a slave control module. Referring to FIG. 3, the slave control module 20 comprises an RFID receiver 22, a second Bluetooth transceiver 24, a second microprocessor 26, a power supply 25, and a key 28.

In this embodiment, in a state that a user is allowed to start a vehicle, after the user presses down the key 28, the slave control module 20 controls the master control module 10 to operate in a pairable mode. In the pairable mode, the first Bluetooth transceiver 14 of the master control module 10 is paired with a device with another Bluetooth transceiver. After being paired, the device with another Bluetooth transceiver has an unlocking authority and serves as a backup key. The device with the Bluetooth transceiver is, for example, a mobile phone or a personal digital assistant (PDA).

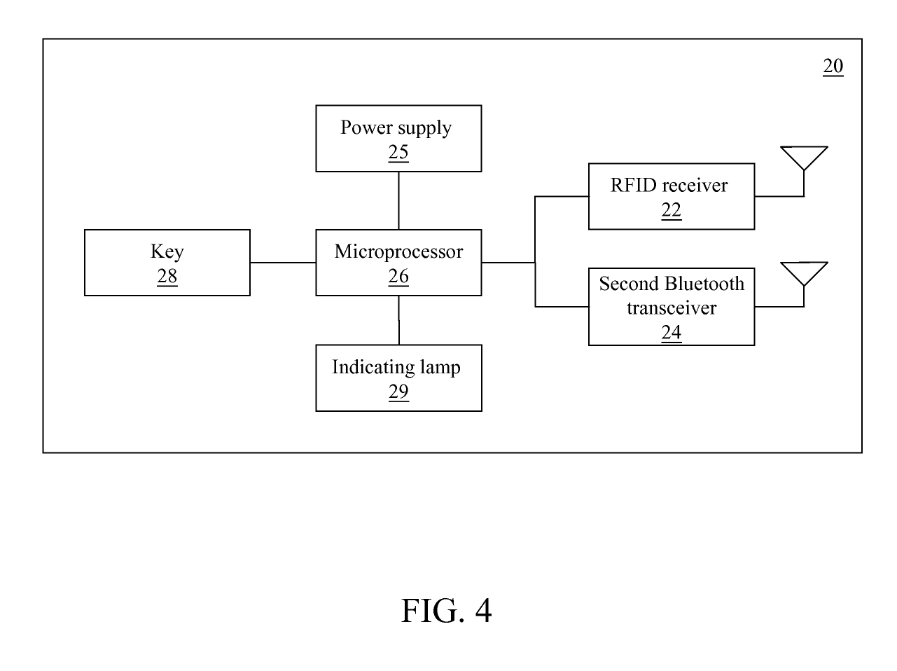

FIG. 4 is a system block diagram of a third embodiment of a slave control module. Referring to FIG. 4, the slave control module 20 comprises an RFID receiver 22, and second Bluetooth transceiver 24, a second microprocessor 26, a power supply 25, a key 28, and an indicating lamp 29.

Furthermore, the slave control module 20 reads a pairing parameter. The pairing parameter comprises, for example, (1) whether another Bluetooth transceiver requires inputting a password; (2) a quantity and a priority of another Bluetooth transceiver capable of being paired; (3) whether vehicle information is allowed to be transmitted to another Bluetooth transceiver.

When the second microprocessor 26 detects that a voltage supplied by the power supply 25 is lower than a critical value, the indicating lamp 29 continuously flickers, so as to remind the user to replace the battery.

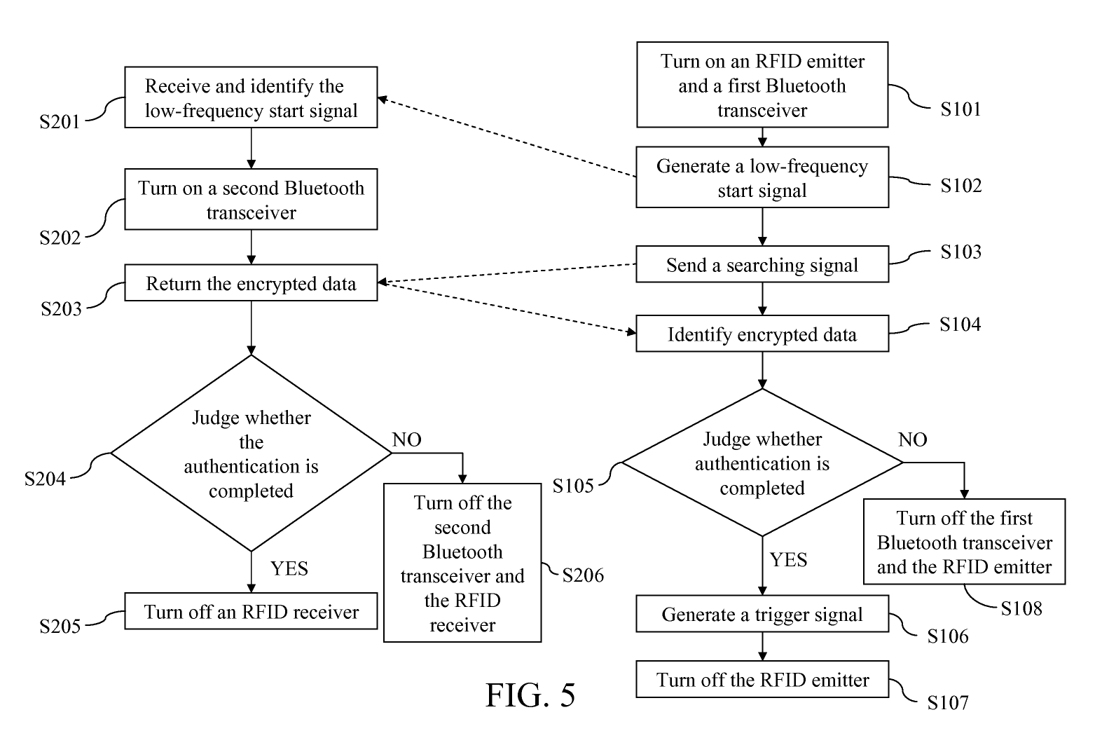

FIGS. 1 to 4 illustrate hardware architectures of the master control module 10 and the slave control module 20. For the detailed operation modes of the master control module 10 and the slave control module 20, please refer to FIGS. 5 to 8.

FIG. 5 is a flow chart of a first embodiment of a non-contact control method.

In Step S101, when a state of a switch 15 is changed, the switch 15 transmits a start signal to a first microprocessor 16. The first microprocessor 16 turns on an RFID emitter 12 and a first Bluetooth transceiver 14.

In Step S102, after being turned on, the RFID emitter 12 generates a low-frequency start signal.

In Step S201, the RFID receiver 22 receives the low-frequency start signal. After receiving the low-frequency start signal, the RFID receiver 22 identifies whether the low-frequency start signal satisfies a preset value. The identification mechanism can be considered as first-layer authentication and unlocking.

If the low-frequency start signal is identified to be correct, a second microprocessor 26 is switched from an OFF mode to an ON mode. In Step S202, the second microprocessor 26 turns on a second Bluetooth transceiver 24. The second microprocessor 26 is switched to the ON mode only after receiving the low-frequency start signal, such that the second microprocessor 26 is maintained at a non-power consuming OFF mode in most of the other time.

In Step S103, the first Bluetooth transceiver 14 sends a searching signal to search the second Bluetooth transceiver. In Step S203, after receiving the searching signal, the second Bluetooth transceiver 24 returns encrypted data to the first Bluetooth transceiver 14. In Step S104, the first Bluetooth transceiver 14 decrypts the encrypted data, and identifies whether the decrypted data satisfies a preset value. The identification mechanism is considered as second-layer authentication and unlocking.

If the decrypted data is identified to be correct, the first Bluetooth transceiver 14 notifies the second Bluetooth transceiver 24 that an authentication procedure is completed.

In Step S105, the first Bluetooth transceiver 14 judges whether the authentication is completed.

If yes, Step S106 is performed, that is, the master control module 10 transmits a trigger signal to the circuit control device 30, so as to allow a user to start a vehicle, and allow the user to open a vehicle door or directly start the vehicle. Moreover, in Step S107, the RFID emitter 12 is turned off.

If no, it indicates that the switch 15 may be mis-touched, or the first Bluetooth transceiver 14 cannot search another Bluetooth transceiver. Therefore, the first Bluetooth transceiver 14 and the RFID emitter 12 are turned off.

In Step S204, the second Bluetooth transceiver 24 judges whether the authentication is completed.

If yes, Step S205 is performed, and the RFID receiver 22 is turned off. When being turned off, the RFID receiver 22 enters a power-saving state, and still can receive signals.

If no, it indicates that the slave control module 20 may be turned on due to an error signal. Therefore, the RFID receiver 22 and the second Bluetooth transceiver 24 are turned off, and the second microprocessor 26 is switched to the OFF mode.

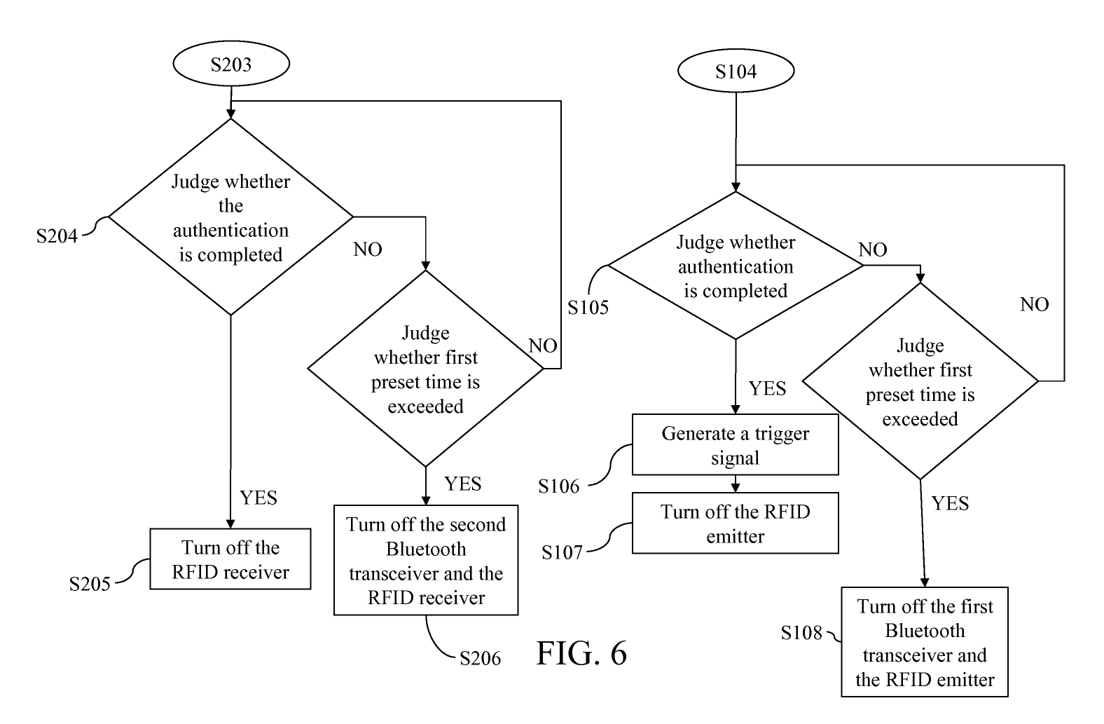

FIG. 6 is a flow chart of a second embodiment of a non-contact control method. In order to reduce probability of misjudgment in Step S105, in Step S105, if the first judgment is no, the first microprocessor 16 starts timing. When a timing result of the first microprocessor 16 is smaller than first preset time, the judgment in Step S105 is performed. Therefore, as long as the authentication of the first Bluetooth transceiver 14 and the second Bluetooth transceiver 24 is completed within the first preset time, the probability of the misjudgment, in which the authentication cannot be completed, is reduced. Similarly, Step S204 has the same mechanism.

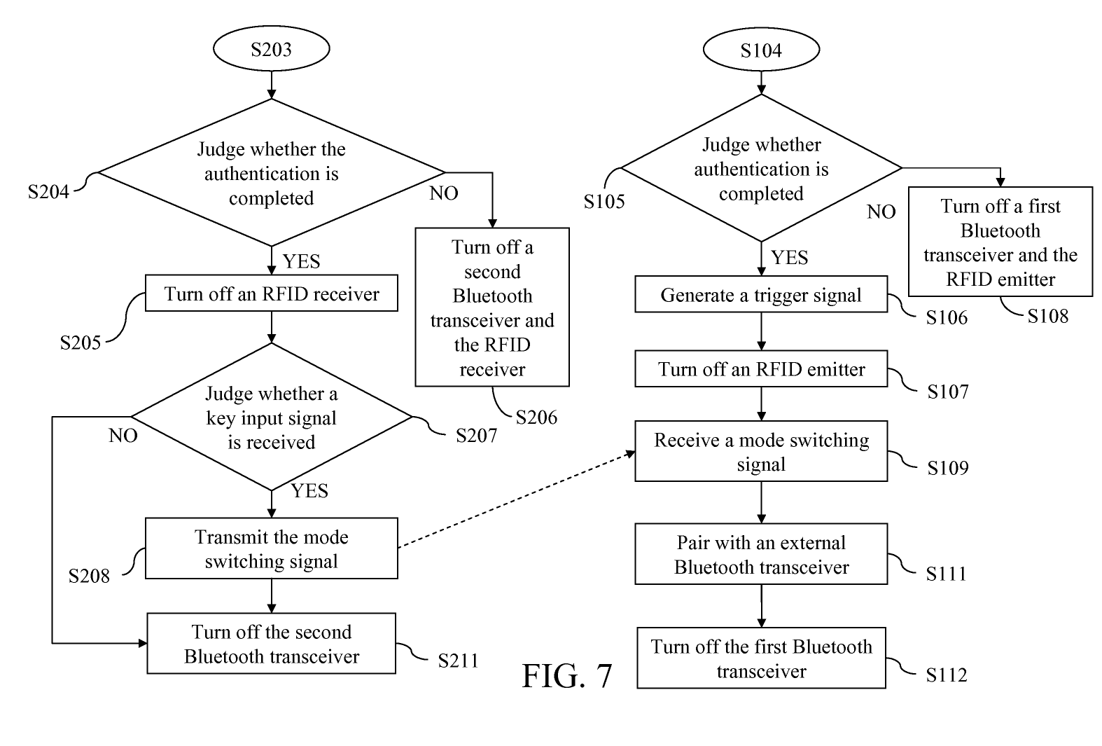

FIG. 7 is a flow chart of a third embodiment of a non-contact control method, and steps of FIG. 7 follow Steps S201 to S206 and Steps S101 to S108 of FIG. 5.

In Step S207, a second microprocessor 26 judges whether a key signal is received. If a user presses down a key 28, the second microprocessor 26 receives the key signal.

Then, in Step S208, a second Bluetooth transceiver 24 transmits a mode switching signal. In Step S109, a first Bluetooth transceiver 14 receives the mode switching signal.

In Step S111, after receiving the mode switching signal, a master control module 10 is operated in a pairable mode. In the pairable mode, the master control module 10 can be paired with a device with another Bluetooth transceiver. After being paired, the device with another Bluetooth transceiver has an unlocking authority and serves as a backup key.

In Step S211, after transmitting the mode switching signal, the second Bluetooth transceiver 24 is turned off, so as to save power consumption. Similarly, in Step S112, after being paired with another Bluetooth transceiver, the first Bluetooth transceiver 14 is turned off.

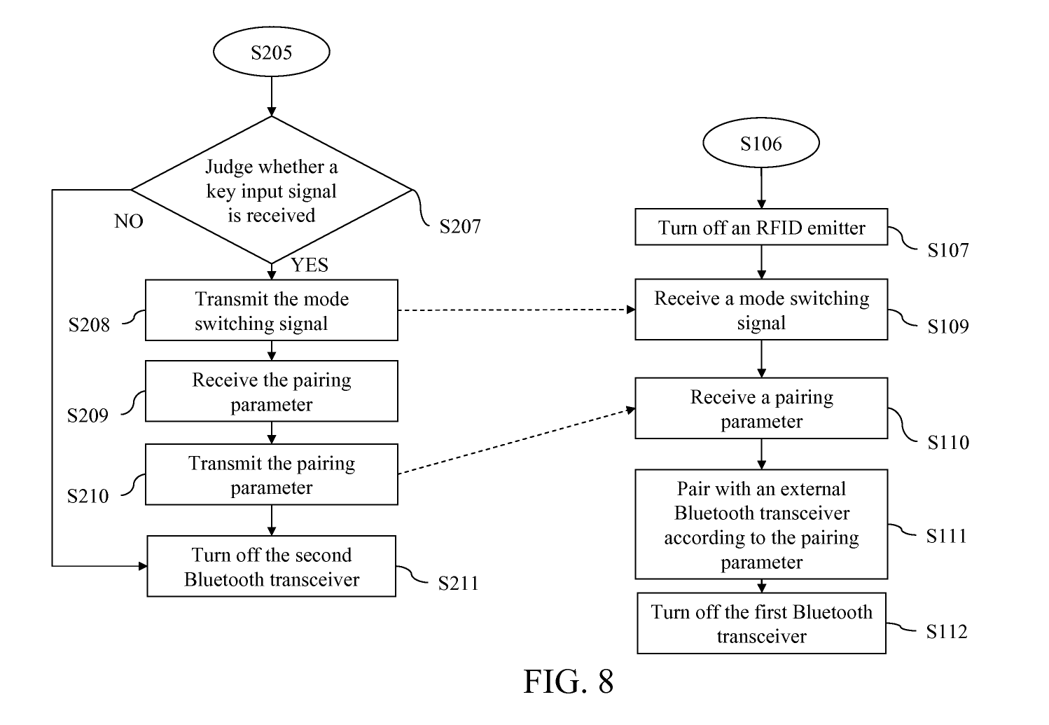

FIG. 8 is a flow chart of a fourth embodiment of a non-contact control method. In order to further set an authority of another Bluetooth transceiver, a slave control module 20 sets a pairing parameter.

In Step S209, the pairing parameter is read, and is received by a second microprocessor 26. In Step S210, the pairing parameter is transmitted by a second Bluetooth transceiver 24.

In Step S110, the first Bluetooth transceiver 14 receives the pairing parameter. In Step S111, the first Bluetooth transceiver 14 is paired with another Bluetooth transceiver according to the pairing parameter. In this manner, it is possible to limit whether another Bluetooth transceiver requires inputting a password, a quantity and the priority of another Bluetooth transceiver capable of being paired, or whether another Bluetooth transceiver can read vehicle information.

In view of the above, in the non-contact control device and the non-contact control method according to the present invention, the master control module 10 actively turns on the slave control module 20, such that the slave control module 20 is maintained at the OFF mode usually, so as to save the power consumption. Furthermore, the RFID receiver 22 firstly identifies whether the low-frequency start signal is correct, and the first Bluetooth transceiver 14 identifies the encrypted signal. In other words, the non-contact control device and the non-contact control method require double identification (the first-layer authentication and unlocking and the second-layer authentication and unlocking), so as to reduce probability of being pirated, thereby further improving security in use.

In addition, in the non-contact control device and the non-contact control method according to the present invention, the first Bluetooth transceiver is paired with another Bluetooth transceiver, such that another Bluetooth transceiver has the unlocking authority and serves as the backup key. As the pairing process is performed by the first Bluetooth transceiver of the master control module, any device with another Bluetooth transceiver, for example, a common Bluetooth mobile phone, can serve as the backup key after being paired. In the present invention, authorities of the backup keys are further managed by using parameters of the slave control module, so as to improve the security.

What is claimed is:

1. A non-contact control method, applicable to a master control module and a slave control module, wherein the master control module is electrically connected to a circuit control device, the master control module comprises a radio frequency identify (RFID) emitter, a first Bluetooth transceiver, and a switch, the slave control module comprises an RFID receiver and a second Bluetooth transceiver, the method comprising:
turning on the RFID emitter and the first Bluetooth transceiver, generating a low-frequency start signal by the RFID emitter, and sending a searching signal by the first Bluetooth transceiver;
turning on the second Bluetooth transceiver, when the RFID receiver receives the low-frequency start signal and identifies that the low-frequency start signal is correct;
returning encrypted data, when the second Bluetooth transceiver receives the searching signal; and
sending a trigger signal by the master control module to the circuit control device, when the first Bluetooth transceiver identifies that the encrypted data is correct.

2. The non-contact control method according to claim 1, further comprising:
receiving a key input signal through the slave control module;
transmitting a mode switching signal to the first Bluetooth transceiver; and
pairing the first Bluetooth transceiver with another Bluetooth transceiver, after receiving the mode switching signal.

3. The non-contact control method according to claim 2, wherein after the mode switching signal is transmitted to the first Bluetooth transceiver, the method further comprises:
transmitting a pairing parameter through the second Bluetooth transceiver of the slave control module; and
pairing the first Bluetooth transceiver with another Bluetooth transceiver, according to the pairing parameter.

4. The non-contact control method according to claim 3, wherein the pairing parameter comprises:
whether another Bluetooth transceiver requires inputting a password;
a quantity and a priority of another Bluetooth transceiver capable of being paired; or
whether another Bluetooth transceiver is capable of reading vehicle information.

5. The non-contact control method according to claim 1, wherein after the master control module sends the trigger signal to the circuit control device, the method further comprises:
turning off the RFID emitter; and
turning off the RFID receiver.

6. The non-contact control method according to claim 1, wherein after the encrypted data is returned, the method further comprises:
judging whether authentication is completed, and if no, turning off the RFID emitter and the first Bluetooth transceiver, or turning off the RFID receiver and the second Bluetooth transceiver.

7. A non-contact control device, comprising a master control module and a slave control module, wherein the master control module is electrically connected to a circuit control device, the master control module comprises a radio frequency identify (RFID) emitter, a first Bluetooth transceiver, and a switch, the slave control module comprises an RFID receiver and a second Bluetooth transceiver, the switch turns on the RFID emitter and the first Bluetooth transceiver of the master control module, the RFID emitter sends a low-frequency start signal to the RFID receiver, so as to turn on the second Bluetooth transceiver, the first Bluetooth transceiver sends a searching signal to the second Bluetooth transceiver, and the second Bluetooth transceiver returns encrypted data to the first Bluetooth transceiver, such that the master control module sends a trigger signal to the circuit control device.

8. The non-contact control device according to claim 7, wherein the slave control module further comprises a key, when the key is pressed down, the slave control module controls the master control module to operate in a pairable mode, and the first Bluetooth transceiver of the master control module is capable of being paired with another Bluetooth transceiver.

9. The non-contact control device according to claim 8, wherein the slave control module is used to set a pairing parameter, and the first Bluetooth transceiver is paired according to the pairing parameter.

10. The non-contact control device according to claim 9, wherein the pairing parameter comprises:
whether another Bluetooth transceiver requires inputting a password;
a quantity and a priority of another Bluetooth transceiver capable of being paired; or
whether another Bluetooth transceiver is capable of reading vehicle information.

11. The non-contact control device according to claim 7, wherein the RFID receiver identifies the low-frequency start signal, and when the RFID receiver identifies that the low-frequency start signal is correct, a microprocessor of the slave control module is switched from an OFF mode into an ON mode.

12. The non-contact control device according to claim 11, wherein the RFID receiver identifies the low-frequency start signal, and when the RFID receiver identifies that the low-frequency start signal is correct, the second Bluetooth transceiver is turned on.

13. The non-contact control device according to claim 7, wherein after the master control module sends the trigger signal to the circuit control device, the RFID emitter and the RFID receiver are turned off.
